(19) United States
(12) Patent Application Publication
(10) Pub. No.: US 2011/0224868 A1
(43) Pub. Date: Sep. 15, 2011

(54) System for Determining Driving Pattern Suitability for Electric Vehicles

(75) Inventors: John K. Collings, III, Mableton, GA (US); Robert Wachtel, Clearwater, FL (US)

(73) Assignee: John K. Collings, III, Mableton, GA (US)

(21) Appl. No.: 13/007,754

(22) Filed: Jan. 17, 2011

Related U.S. Application Data
(60) Provisional application No. 61/313,437, filed on Mar. 12, 2010.

(51) Int. Cl. G06F 19/00

(52) U.S. Cl. 701/35

(57) ABSTRACT

In a method of evaluating vehicle suitability for a driver, data relating to driving habits of the driver over a period of time are recorded into a digital memory. A driving behavior profile of the driver based on the data is determined with a computer processor. A computer-generated report indicating expected results of operating at least one vehicle of a selected type based on the driving behavior profile is generated.

### CROSS-REFERENCE TO RELATED APPLICATION(S)

This application claims the benefit of U.S. Provisional Patent Application Ser. No. 61,313,437, filed Mar. 12, 2010, the entirety of which is hereby incorporated herein by reference.

### BACKGROUND OF THE INVENTION

1. Field of the Invention

The present invention relates to automobile evaluation systems and, more specifically, to a system that allows a consumer to predict vehicle performance based on driving habits.

2. Description of the Prior Art

Electric vehicle technology is maturing to the point where electric vehicles are increasingly used for commuter travel and the like. While internal combustion engine vehicles are still used by many, new electric vehicle models are being offered by automobile dealerships. Current battery and hybrid drive technology produce vehicles with one tenth to one third the electric driving range of a standard gasoline powered vehicle, causing prospective buyers of electric vehicles to have concerns as to whether or not these vehicles will provide them full travel utility without draining the batteries to the point of damage or to the point of becoming stranded. This is commonly referred to as range anxiety.

There are three solutions to range anxiety: (1) do not buy an electric car; (2) buy a plug in hybrid; or (3) buy a pure electric with the confidence that the driver's driving profile matches the electric car. The plug in hybrid is an electric vehicle with a permanent on board gasoline driven electric generator that powers the vehicle when the batteries have been range exhausted. While this solves the range anxiety consumer issue, hybrid vehicles have an inherent added concern in that plug in hybrids must trade off battery capacity for cost, complexity and weight of a redundant drive assembly (i.e., an internal combustion engine-based assembly). Therefore given current technologies, plug in hybrids will have about a third more cost and two thirds less electric range than the pure battery electric vehicles. This is a primary reason it is expected that only one in three “electric vehicles” will be plug in hybrids as opposed to pure battery electric in the future.

Since there is currently little existing consumer experience with electric vehicles, potential electric vehicle buyers often have pre-purchase questions, such as “will the car ever leave me stranded?”

Estimating an electric vehicle's range between charging is depends on the driving profile of the driver and the type of trip or trips taken. The amount of energy needed for 50 miles of secondary street travel is substantially different than 50 miles of highway travel at 70 miles per hour. Many factors other than speed affect energy use during travel such as acceleration and deceleration habits, terrain and vehicle load. Also, there are the inevitable intraday travel variances from a driver's normal routine. All these variables affect a driver's energy use for travel. Therefore, estimating a driver's personal driving range needs from an electric vehicle is much more difficult than simply adding up the expected miles. This range evaluation problem is at the core of consumer “range anxiety”.

Therefore, there is a need for a system for accurately predicting electric vehicle driving range prior to purchase of a vehicle to determine its suitability for a in specific driver based on that driver's driving habits.

### SUMMARY OF THE INVENTION

The disadvantages of the prior art are overcome by the present invention which, in one aspect, is a method of evaluating vehicle suitability for a driver, in which data relating to driving habits of the driver over a period of time are recorded into a digital memory. A driving behavior profile of the driver based on the data is determined with a computer processor. A computer-generated report indicating expected results of operating at least one vehicle of a selected type based on the driving behavior profile is generated.

In another aspect, the invention is a system for evaluating vehicle operation associated with a driver that includes a portable device and a processor. The portable device that is configured to be placed in a first vehicle of the driver and to record data relating to driving habits of at least one user of the first vehicle during a period of time. The processor is configured to: read the data from the portable device; determine a driving behavior profile of the at least one user of the first vehicle based on the data read from the portable device; and generate a report indicating expected results of operating at least one vehicle of a selected type based on the driving behavior profile.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram of one embodiment of a portable device.

FIGS. 2A-2B are schematic diagrams of a board layout for an embodiment of a portable device.

FIG. 3 is one example of a report generated by the system.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet.

One representative embodiment is a method and apparatus that allows a user to simulate driving an electric vehicle to determine if the electric vehicle would be suitable, given the driver's driving habits and travel history. The embodiment also estimates and compares the conventional and electric travel costs given certain user characteristics.

While driving habit data could be input to the computer manually, one embodiment uses a device that a user places in an existing conventional vehicle. The device records in detail the vehicle travel over a period of time that would be representative of the user's real world travel requirements and experiences. In this embodiment the device can record in detail such information as: the time of the conventional vehicles location, its speed, its acceleration and deceleration, its elevation, the external temperature, the internal temperature and other power related parameters. It would do so through the use of a GPS receiver, accelerometers, thermometers and other related sensors. The data would be stored in electronic memory inside the device. The data may be processed and the results displayed on the device or the data would be transferred to a central computer system via electronic cable connection or via a periodic wireless transfer. In one embodiment, the system could be embodied in an existing type of personal electronics device, such as a cellular telephone or a GPS device.

A driver inputs vehicle travel data based on current or historical travel patterns. This vehicle travel data is used to determine the amount of power required for the vehicle travel and then calculate the electricity that would be required by an electric vehicle being driven in a similar manner by the driver. In as simple embodiment, the travel data can include such information as the mileage between destinations typically driven to by the driver.

One embodiment collects more information so as to provide a more precise estimate of the power requirements that would be placed on a hypothetical electric vehicle. Such information can include the following: acceleration and deceleration rates; speed; altitude changes; time of day and related traffic patterns; ambient temperature; use of auxiliary systems (such as radios and air conditioners); and any other type of information that would have an effect on power consumption by an electric vehicle. This information allows the system to determine whether and when a certain electric car will require recharging during normal driving by the driver. This information could also allow the system to estimate the economic and ecological savings of using a given electric vehicle versus a conventional internal combustion powered vehicle. This information could also allow the system to estimate the wear on a certain type of battery due to levels of discharge and subsequent charging.

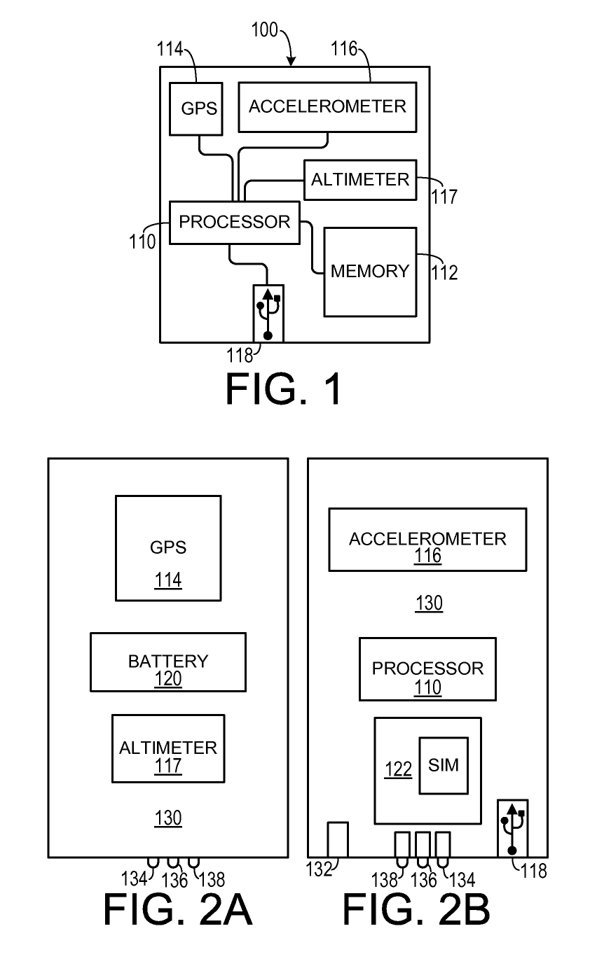

One embodiment, as shown in FIG. 1, employs a portable driving habit data recording device 100 that the driver can place in a car. The portable device 100 is configured to record data relating to the driver's habits over a period of time. The portable driving habit data recording device 100 includes a plurality of sensors that can be used to sense the driver's driving habits. For example, the sensors can include a global positioning system (GPS) chipset 114, which can determine the location of the car at any given time, an accelerometer 116 (such as a three-axis accelerometer), which can measure the driver's acceleration and deceleration habits and an altimeter 117, which can measure the driver's altitude. The sensors provide sensor data to a local processor 110 that stores the data in a memory 112 (which could include, e.g., a flash memory, a memory card or portable hard drive). Once a data-collecting period (e.g., a week) has ended, the local processor 110 can upload the data to a computer via a data port 118, such as a USB connection.

While the GPS chipset 114 can detect altitude and location, it has limited precision. The altimeter 117, on the other hand, is much more precise. However, it is subject to anomalous measurements due to rapid changes in air pressure as a result of such events as a window being opened or an air conditioner being turned on. Therefore, the processor 110 compares data from the GPS chipset 114 to data from the altimeter 117 to make an accurate and precise determination of the vehicle's altitude. Similarly, the GPS chipset 114 can determine location, but does not measure acceleration and deceleration accurately due to its low precision. The accelerometer 116 measures acceleration and deceleration with precision but does not measure velocity. Therefore, the processor 110 compares data from the GPS chipset 114 to data from the accelerometer 116 to make an accurate and precise determination of the vehicle's acceleration, deceleration, speed and direction.

A 3-axis accelerometer has the ability to gauge the orientation of a stationary platform relative to the earth's surface. Thus, a technique for determining the incline of a 3-axis MEMs accelerometer is to determine the incline at rest and then to observe the 3 vectors as the vehicle moves. By subtracting the motion vectors, the true incline and incline change can be calculated. A technique for calibrating the accelerometer is to note the acceleration along 3-axes at rest and compare it to the vectors of a two axis thermal accelerometer in two planes but mounted next to the 3 axis accelerometer. The difference between the two readings indicates the incline and the change in incline. In this manner, the housing can be tilted in reference to the earth, but the change in incline (which can be used to determine work) can be calculated. A confirmation of that change in elevation angle can be determined by a barometric pressure sensor and can be used to determine the change in elevation based on altitude and vertical velocity based on the angle. This feedback loop improves accuracy.

One possible circuit board layout of a portable driving habit data recording device 100 is show in FIGS. 2A (which shows a first side of the board) and 2B (which shows an opposite second side of the board). In one embodiment, the layout would include the devices mentioned above and also a cellular telephone chipset 122 (which could be used to transfer data to a computer), including a SIM card. An onboard battery 120 would provide power to the other devices on the board and 12V DC jack 132 can be used to recharge the battery 120. A first light emitting diode (LED) 138 could be used to indicate if the device is on; a second LED 136 indicates if the device has a sufficient GPS lock; and third LED 134 indicates when data is being recorded. Several other components could be included to provide additional data, such as: an inclinometer, a barometer and a thermometer.

The driving habit data recording device 100 would be affixed to a position in the test vehicle where it could achieve a good lock on GPS satellites and not move once data gathering starts. It could be affixed with one of many different devices (including: suction cups, two sided tape, a hook and loop fastener, a “bean bag” weighted underside, etc.). Securing the device to the vehicle prevents it from slipping during travel and thus causing erroneous speed and acceleration readings.

Typically, the driving habit data recording device 100 would be powered both by the internal battery 120 and the 12V DC jack 132 powered by the vehicle's cigarette lighter outlet. When the driving habit data recording device 100 senses a charging voltage, typically greater than 13 V at the 12V DC jack 132—which indicates that the vehicle's engine has been turned on and has engaged the alternator, the driving habit data recording device 100 powers up its sensor electronics, obtains GPS lock and begins recording data. When the accelerometer 116 indicates movement, the processor 110 will indicate that the vehicle has started a new route. When the GPS chipset 114 and the accelerometer 116 detect that the vehicle has stopped and when the charging voltage is still detected at the 12V DC jack 132, the processor 110 still records the stop as being part of the route. However, when the voltage sensed drops to below the charging voltage, indicating that the engine is not running, then the processor records data indicating that the route has terminated. When the vehicle is not operating, the driving habit data recording device 100 would be in a low power sleep mode where it samples the voltage of the 12V DC jack 132 periodically to determine if the engine has started, but would not otherwise power up any of the other devices.

One embodiment employs an algorithm in which when alternator power (e.g., charging voltage) is detected and when the velocity is greater than zero, the position, date, and time are marked in the record as the trip start time. When alternator power is off and the velocity equals zero, then the position, date, and time are marked in the record as the trip end time. Trip events are also recorded. For example, when the altitude or the velocity (or both) is different by 5% from the previous held value, then the time and sensor values are recorded. The determination of altitude is based on the altimeter (air pressure sensor) in conjunction with the altitude report from the GPS. This is smoothed and run through a filter. The specifics of this smoothing and special filter is dynamic based on how accurate the GPS is, which is a function of the number of satellites of the fix, the reception of a Wide Area Augmentation System (WAAS) signal if one is available and what types satellites are detected. In one embodiment, the determination of velocity is primarily based on the GPS velocity reading. The accelerometer can ascertain the instantaneous acceleration in the forward direction. Also, the addition of magnetometers and gyroscopes can the give the system give degrees of freedom. The altimeter may also have an associated temperature sensor. In addition, in one embodiment the system is also coupled to the vehicle's controller area network (CAN-bus) to receive vehicle operating data, which can provide additional information regarding the user's driving habits.

Additional determinations regarding the driver's driving habits can be derived from publicly-available sources. For example, the use of topographic maps, stop sign and traffic light locations, average traffic congestion patterns at certain times of the day and historical weather data can be employed to make more accurate estimates of the energy costs that a driver could expect during normal driving. The system could also take into account locations of different charging services. For example, if the user were to have a charging station at the office parking lot, then the car could be charged during normal working hours and this charging could influence the driver's experience with an electric vehicle.

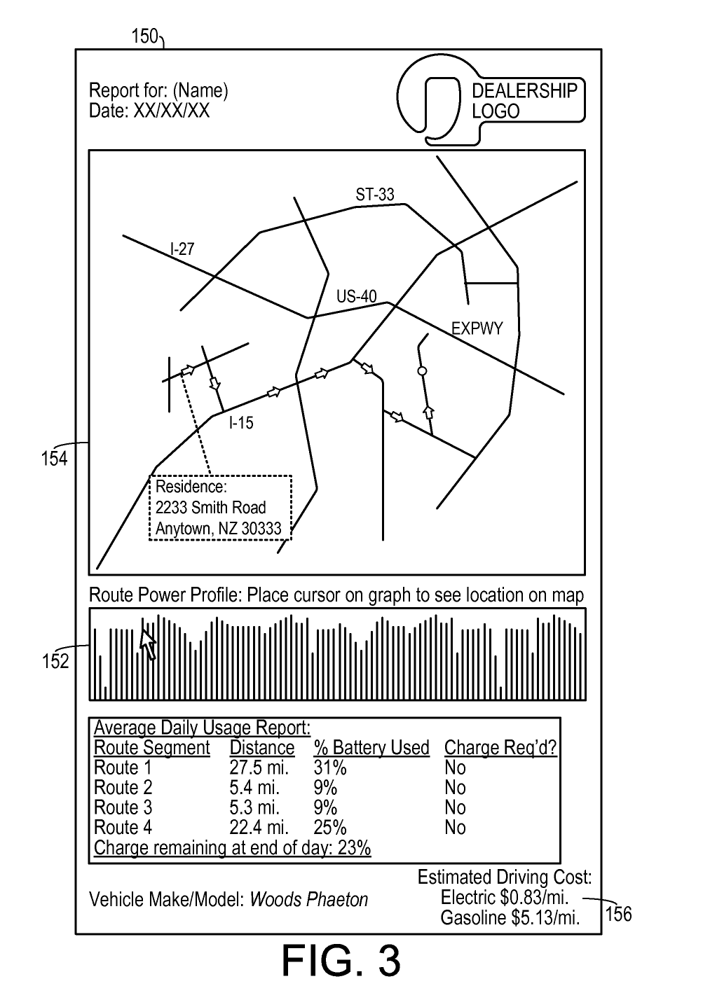

As shown in FIG. 3, a computer generates a report 150 relating collected data to a prediction of the experience the driver would have with an electric vehicle. One embodiment of the report is displayed on a computer monitor and is interactive. For example, it could include an expected power usage graph 152 that breaks down the driver's travel broken down to a plurality of travel segments and it could also allow the user to click on individual segment lines on the graph to show the corresponding usage segments on a map 154. The report 150 could also include a comparison of the cost difference between using a given electric vehicle and the driver's current internal combustion engine-powered vehicle 156.

The computer could also predict the experience that the driver would have with several different vehicles. For example, the computer could generate a report that would indicate the cost and the amount of time spent recharging that would be experienced by the driver if the driver were to operate each of several different brands of electric vehicle.

Battery capacity is also affected by temperature. The program could generate range and trip consequence estimates given different ambient temperatures and also atmospheric pressures. This could be done by accessing historical weather data via the global computer network and then calculating the effect on vehicle power consumption resulting from the average weather patterns for the period that driving habit data was collected. Also, varying temperatures would likely result in the electric vehicle users using different amounts of heating and air conditioning which would also affect the amount of power used. The program could additionally estimate the range and trip consequences given different heating and air conditioning usage though substantial variances could be expected as the duration of the trip would affect the total power usage.

The program could also allow the user to input assumptions about travel parameters manually, or the program could automatically make certain assumptions about the travel based on simple destination location inputs. An example of this would be the use of speed assumptions based on the route of travel. Highway routes would assume highway speeds and primary and secondary routes would assume like speeds. Historical traffic patterns could also be used to adjust speed assumptions. Additionally, routes could be analyzed for stop signs and traffic light involvement with assessments for time and acceleration/deceleration power consumption. Additionally, routes could be analyzed and compared with topology data to estimate power consumption given uphill and downhill travel.

More accurate power consumption estimates can be made as compared with simple location and distance calculations by collecting travel data with speed, acceleration, temperature and time.

One embodiment does not use a driving habit data recording device, but requires the driver to input driving habit data manually. This embodiment could use a dedicated program or a Web-based service. In this embodiment a driver would input locations and sequence of travel. From this data the program would analyze travel distance and other related parameters. The program could further determine the type of road used during travel (Interstate, primary, secondary) and estimate the probable speed, number of stops and altitude changes, etc. With these parameters an estimate of electric power used could be made. The power estimates would then be compared to electric vehicle power usage given the individuals driving profile, as applied to specific electric vehicles or to an average model of an electric vehicle. The program could then estimate how much electricity would be used by the electric vehicle given a full charge at the starting point of a trip and whether the trip would have required inter-destination recharging. The program could also estimate how much inter-destination charging would be required for successful completion of the trip. The program could also estimate the consequences of missed charging.

A neural network may be employed to process data recorded by the recording device to generate a highly precise prediction of an electric vehicle's usage characteristics for a given user. By placing a data recording device in an electric vehicle and by measuring the battery's state of charge, actual feedback can be provided into a simulator to provide a highly precise result. Driving parameters may thus be determined through a prescribed process.

In such a neural network, a matrix will include the set of parameters from the data recording device that generate a, the scalar value of the states of charge of the vehicle. In one embodiment, the following process will occur: 1. The weights of the system will be pre-set; 2. The single trip data will be run through the neural network to determine states of charge; 3. an error vector will be created using least squares; 4. an iterative process will be created to establish a minimal error and a candidate weighting matrix; 5. Another trip data will be run through the modified neuron to determine new state of charge (SOC); 6. an iterative process will be created to establish a minimal error and a candidate weighting matrix; 7. Determine if the error is converging; and 8. if not, rework weighting matrix using a sub-optimal least squares to ascertain convergence and system error. This system employs a simple architecture but a high computational load. Data should be retained and every time a new trip data is obtained, a re-run of all of the data is performed in order to insure proper convergence. Based on this data, a dynamic set of past data is retained for regression analysis.

In one embodiment, the following variables are represented the matrix of the neural network:
electric vehicle mass
electric vehicle rolling resistance
electric vehicle aerodynamic resistance
drag coefficient
frontal area
wind speed
air temperature
road grade angle
velocity at trip events
time of trip events
outside temperature
battery temperature
internal battery resistance as a function of states of charge
battery efficiency
car accessories load
A/C load
recoverable energy in regenerative braking
drive train discharge efficiency
effects of driving style

Using the test host vehicle's electric power supply reduces the device's onboard battery power requirements and provides a reliable means of determining the beginning and end of a travel route without having to rely on motion related sensors which would require constant device power. There are many other methods that might be used to determine the beginning and end of a travel route without motion related sensors. One other method would involve using a wired or wireless device connected to the vehicles diagnostic computer connection, such as a CAN bus or OBD 2 connection. Activity on one of these connections would also indicate the beginning and end of travel routes. Also, the device could have a user input such as a button or switch to indicate the beginning and end of a travel; however, this might negate true automation of the driving test.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method of evaluating vehicle suitability for a driver, comprising the steps of:
a. recording, into a digital memory, data relating to driving habits of the driver over a period of time;
b. determining with a computer processor a driving behavior profile of the driver based on the data; and
c. generating a computer-generated report indicating expected results of operating at least one vehicle of a selected type based on the driving behavior profile.

2. The method of claim 1, wherein the recording step comprises the steps of:
a. placing a portable device into a first vehicle of the driver, the portable device configured to record data relating to driving habits of at least one user of the first vehicle during a period of time;
b. placing the portable device in data communication with the computer; and
c. instructing the computer to read the data from the portable device.

3. The method of claim 1, wherein the recording step comprises manually entering data into the computer.

4. The method of claim 3, wherein the data include information about vehicle heating and air conditioning use.

5. The method of claim 3, wherein the data include information about a travel route frequently taken by the driver.

6. The method of claim 1, wherein the at least one vehicle of a selected type comprises an electric vehicle and wherein the generating step comprises determining power usage in view of predetermined recharging episodes at a plurality of different charging locations along a selected route.

7. The method of claim 6, wherein the predetermined recharging episodes are based on known electric vehicle charging locations.

8. The method of claim 1, wherein the at least one vehicle of a selected type comprises a vehicle with hybrid drive capability and wherein the generating step comprises determining whether the least one vehicle of a selected type would be capable of all electric travel on at least one predefine rout.

9. The method of claim 8, further comprising the step of estimating an electric range indicating a range of the vehicle while operating in an all-electric-powered mode and a gasoline range indicating a range of the vehicle while operating in a gasoline-powered mode.

10. The method of claim 1, wherein the generating step further comprises including the effects of environmental factors in the computer-generated report.

11. The method of claim 10, wherein the environmental factors include historical averages in ambient temperature in an area of a predetermined route.

12. The method of claim 1, wherein the data include operational parameters selected from a group consisting of: time, location, speed of travel, direction of travel, current positive and negative horizontal gravity forces imposed and the vectors of those gravity forces, altitude changes from a previously recorded travel data point, temperature and combinations thereof.

13. A system for evaluating vehicle operation associated with a driver, comprising:
a. a portable device that is configured to be placed in a first vehicle of the driver and to record data relating to driving habits of at least one user of the first vehicle during a period of time; and
b. a processor configured to:
i. read the data from the portable device;
ii. determine a driving behavior profile of the at least one user of the first vehicle based on the data read from the portable device; and
iii. generate a report indicating expected results of operating at least one vehicle of a selected type based on the driving behavior profile.

14. The system of claim 13, wherein the portable device comprises:
a. a digital memory;
b. a local processor in communication with the digital memory;
c. a global positioning system module in communication with the local processor;
d. an accelerometer in communication with the local processor;
e. an altimeter in communication with the local processor; and
f. a data port configured to communicate data from the local processor to an external device.

15. The system of claim 14, wherein the processor is further configured to:
a. compare data from different sensors in the portable device to detect data anomalies; and
b. record data that has been corrected for the anomalies.

16. The system of claim 13, wherein the vehicle of the selected type comprises an electric vehicle and wherein the report indicates whether the driver is likely to have an adequate power reserve if the user drives the selected type of vehicle.

17. The system of claim 13, wherein the report indicates an expected cost of operating the vehicle of the selected type.

18. The system of claim 13, wherein the data include operational parameters selected from a group consisting of: time, location, speed of travel, direction of travel, current positive or negative horizontal gravity forces imposed and the vectors of those gravity forces, altitude changes from the previously recorded travel data point, temperature and combinations thereof.

19. The system of claim 13, further comprising a user interface configured to allow the user to input additional data into the processor manually.

20. The system of claim 19, wherein the additional data include information about vehicle heating and air conditioning use.
